(19) United States
(12) Patent Application Publication
(10) Pub. No.: US 2025/0240865 A1
(43) Pub. Date: Jul. 24, 2025

(54) Plasma Torch

(71) Applicant: Alan William Burgess, North Vancouver (CA)

(72) Inventor: Alan William Burgess, North Vancouver (CA)

(21) Appl. No.: 19/034,909

(22) Filed: Jan. 23, 2025

Related U.S. Application Data
(60) Provisional application No. 63/623,827, filed on Jan. 23, 2024.

(51) Int. Cl. H05H 1/34; H05H 1/28

(52) U.S. Cl. CPC H05H 1/3423; H05H 1/28; H05H 1/3405

(57) ABSTRACT

A plasma torch, which includes: a plasma generating unit, a splitter, an elbow, a nozzle, and an injection tube. The plasma generating unit generates a plasma stream. The splitter receives the plasma stream splits the stream of the plasma into at least two secondary plasma streams. The elbow includes angled pipes that bend the secondary plasma streams. The nozzle is joined to the angled pipes and receives the secondary plasma streams to combine the secondary plasma streams into a single combined plasma stream, the nozzle having an ejection hole for ejecting the combined plasma stream out of the plasma torch. The injection tube is located between the angled pipes and configured to inject feedstock into the combined plasma stream at the nozzle, such that the feedstock mixes with the combined plasma stream in the nozzle and exits the plasma torch with the combined plasma stream via the ejection hole.

### CROSS-REFERENCES TO RELATED APPLICATIONS

The present application claims priority to U.S. Provisional Application Ser. No. 63/623,827 filed on Jan. 23, 2024, which is hereby incorporated in its entirety.

### FIELD OF THE INVENTION

This invention relates to plasma spray technology.

### BACKGROUND OF THE INVENTION

Plasma spray technology is a form of thermal spray that was first developed in the 1950's. Plasma spray involves striking an arc between an anode and cathode, ionizing the gas reaching temperatures that can exceed 10,000 K. This hot ionized gas is used to heat and accelerate feedstock materials to produce coatings.

The first commercial plasma spray torches emerged in the 1970s and the focus was coatings for aerospace gas turbine engines. These early plasma gun used radial injection where the powder is injected from the side into the hot plasma gas jet plume. Since powders have a natural size distribution, smaller particles would have difficulty penetrating the plasma jet and larger particles would pass through the jet with only a fraction of the powder being fully entrained inside the plasma. This would result in radial injection having low deposition efficiencies where a significant amount of the feedstock materials is not deposited on the surface as a coating.

Today, plasma spray torches are highly sophisticated devices, capable of processing materials at high temperatures and rates. The development of multi-arc plasma torches, for example, has enabled the production of high-quality coatings with improved surface economics, quality and uniformity. Additionally, the development of plasma spray torches that use powders with fine particle sizes has led to the development of suspension plasma spray.

Plasma spray is useful to spray ceramic oxide materials that have high melting points such as yttria stabilized zirconia that is used as a thermal barrier coating on hot sections within gas turbine components to enable these turbines to operate at higher temperatures. This is of significant interest to jet engine companies such as GE, Pratt & Whitney and Rolls Royce.

In the late 1980's and 1990's, axial injection was developed to improve the efficiency of plasma guns. In this case the powder was generally injected from the back of a linear plasma torch along the center axis of the flame. This resulted in improved efficiencies as all the feed stock material is fully entrained in the hot plasma gas stream.

Axial Plasma also is advantageous in the spraying of coatings from liquid suspension feedstock called Suspension Plasma Spray (SPS). SPS has fine powder with granules sized 100 nm-2 μm, and can produce unique coatings that produce a structure similar to those produced using expensive Electron Beam Physical Vapor Deposition (EB-PVD). Suspension Plasma Spray can significantly reduce the cost to deposit these coatings. Suspension plasma spray (SPS) is used, inter alia, for depositing Thermal Barrier Coatings (TBCs) and Environmental Barrier Coatings (EBCs). TBCs are coatings incorporating a ceramic layer that protect high-temperature components from thermal degradation. EBCs are environmental coatings that incorporate coating layers including ceramic layers to protect structural ceramics such as Silicon Carbide (SiC) form both thermal and chemical degradation from the combustion environment.

In recent years, there have been advances in the SPS of TBCs and EBC's, including new ceramic materials with improved thermal stability, thermal shock resistance, CMAS (Calcium, magnesium, alumina, silicate) resistance, and increased high temperature limit, leading to more durable TBCs and EBC's.

Plasma powder processing has proven to be an effective method for producing modified metal and ceramic particles by remelting in the plasma plume and solidifying within a chamber or quenching device. Having axial powder injection of powder makes the process more efficient as every particle will travel within the plasma plume.

### BRIEF SUMMARY OF EMBODIMENTS OF THE INVENTION

An aspect of some embodiments of the present invention relates to a plasma torch, which includes: a plasma generating unit, a splitter, an elbow, a nozzle, and an injection tube. The plasma generating unit is configured to generate a stream of plasma. The splitter is configured to receive the stream of the plasma from the plasma generating unit and to split the stream of the plasma into at least two secondary plasma streams. The elbow includes angled pipes, each angled pipe having a proximal opening and a distal opening, each angled pipe being configured to receive a respective one of the secondary plasma streams from the splitter via the proximal opening and to bend the secondary plasma streams. The nozzle is joined to the angled pipes and configured to receive the secondary plasma streams from the distal openings of angled pipes, to combine the secondary plasma streams into a single combined plasma stream, the nozzle having an ejection hole for ejecting the combined plasma stream out of the plasma torch. The injection tube is located between the angled pipes and configured to inject feedstock into the combined plasma stream at the nozzle, such that the feedstock mixes with the combined plasma stream in the nozzle and exits the plasma torch with the combined plasma stream via the ejection hole.

In a variant, the injection tube is configured to inject the feedstock co-axially to an axis of the nozzle.

In another variant, the plasma generating unit comprises a cathode, an anode, a hollow tube between the anode and the cathode, and a gas input port configured to receive a gas into the hollow tube, such an arc inside the hollow tube between the cathode and the anode converts the gas into the plasma.

In yet another variant, the plasma torch includes an arc lengthening mechanism configured to lengthen the arc between the anode and the cathode and thereby increase a voltage of the arc.

In a further variant, the cathode partially extends into the hollow tube.

In yet a further variant, the plasma torch includes an insulating ring disposed around the cathode to prevent contact between the cathode and a wall of the hollow tube.

In a variant, the cathode comprises passages configured to lead the input gas from the gas input port upstream into the hollow tube.

In another variant, the cathode is located in a proximal section of the hollow tube, while the anode forms a wall of the hollow at a distal section of the hollow tube.

In yet another variant, the injection tube is straight.

In a further variant, the splitter includes a panel and at least two tubes. The panel has a perforation, covers a distal end of the plasma generating unit, and receives the stream of the plasma from the plasma generating unit via the perforation. The two tubes extend downstream from panel and are in fluid communication with the perforation, to split the stream of the plasma into the secondary plasma streams.

In some embodiments of the present invention, the plasma torch further includes a cooling system which comprises a fluid input line, on or more cavities, and a fluid return line. The one or more cavities are configured to receive a flow of a cooling fluid from the fluid input line, and are in contact with at least a part of an outer surface of a wall of the hollow tube and with at least parts of outer surface of walls of the angled pipes of the elbow. The fluid return line is configured to receive the cooling fluid from the one or more cavities and direct the cooling fluid away from the plasma torch.

In a variant, the one or more cavities contact further the splitter and the nozzle.

In another variant, the splitter comprises a panel and at least two tubes. The panel has a perforation, covers a distal end of the hollow tube, and receives receiving the stream of plasma via the perforation. The at least two tubes extend downstream from the panel and are in fluid communication with the perforation, to split the stream of the plasma into the secondary plasma streams. The panel has an extension region beyond a perimeter of the hollow tube and comprises a plurality of apertures in the extension region, configured to be traversed by the cooling fluid.

In yet another variant, the plasma torch includes a nozzle cap comprising the nozzle and a fluid collection basin in fluid communication with the water return line.

In a variant, the plasma torch includes a nozzle cap which comprises the nozzle, the nozzle cap being removably joined to the elbow.

In another variant, each of the angled pipes comprises a straight proximal segment and a straight distal segment at a non-zero angle with the proximal segment, the proximal segment and the distal segment meeting at a common juncture.

In yet another variant, each of the angled pipes comprises a respective distal segment, the distal segments of the angle pipes converging toward each, before joining the nozzle.

In a further variant, each of the distal segments of the angled pipes comprises a distal end section shaped differently than a remainder of the distal segment and matching a shape of the distal opening.

In yet a further variant, the distal openings are circular, square, kidney-shaped or a combination thereof.

Another aspect of some embodiments of the present invention relates to a plasma jet formation unit configured to be joined to a plasma generating unit and to shape a plasma stream generated by the plasma generating unit into a plasma jet. the plasma jet formation unit includes a splitter, an elbow, a nozzle, and an injection tube. The splitter is configured to receive a stream of plasma generated by a plasma generating unit and to split the stream of the plasma into at least two secondary plasma streams. The elbow includes angled pipes, each angled pipe having a proximal opening and a distal opening, each angled pipe being configured to receive a respective one of the secondary plasma streams from the splitter via the proximal opening and to bend the secondary plasma streams. The nozzle is joined to the angled pipes and configured to receive the secondary plasma streams from the distal openings of angled pipes, to combine the secondary plasma streams into a single combined plasma stream, the nozzle having an ejection hole for ejecting the combined plasma stream out of the plasma jet formation unit. The injection tube is located between the angled pipes and configured to inject feedstock into the combined plasma stream at the nozzle, such that the feedstock mixes with the combined plasma stream in the nozzle and exits the plasma jet formation unit with the combined plasma stream via the ejection hole.

### BRIEF DESCRIPTION OF DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIGS. 1-4 illustrate an axial plasma torch in which the angled pipes lead plasma streams moving along a first axis onto a different axis angled with the first axis, according to some embodiments of the present invention;

FIGS. 5-8 are different views of the splitter, according to some embodiments of the present invention;

FIG. 9-14 illustrates details of the elbow and nozzle cap, according to some embodiments of the present invention;

FIG. 15 illustrates and example of an axial plasma torch of the present invention featuring a longer nozzle;

FIG. 16 shows a bottom view of a bottom plate of the shoulder, in which second openings leading the nozzle are kidney-shaped, according to some embodiments of the present invention; and

FIG. 17 illustrates a three-dimensional view of a cavity of a distal segment of an angled pipe, according to some embodiments of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The inventors have found that conventional axial plasma torches are complex to design. In fact, axial plasma torches of the prior art are generally linear and therefore require that a powder injection tube which either extends along the entirety of the plasma torch or which has an angled or curved shape, for injecting the feedstock coaxially to the plasma flow. Injection tubes are primarily made of hard metal or ceramic which can be difficult to manufacture in curved/angled shapes and are typically straight. For curves in the powder flow line, it is preferred to use soft plastic, Teflon or polyfluorene tubing which exhibit ductility such that they do not exhibit rapid wear from hard particle. However, the injection tube is subject to high temperature above the typical operating range of these plastic, Teflon or polyfluorene polymers. Therefore, the introduction of curves in the injection tubes that can withstand the high temperatures of a plasma torch presents many design and manufacturing difficulties.

In order to allow for a shorter and straight powder injection tube, in the plasma torch of the present invention, the plasma flow is split into a plurality of secondary plasma flows, which follows angled paths with respect to the plane of propagation of the original plasma flow, before being recombined into a combined flow into which the feedstock is injected. The splitting of the plasma flow and the angled path of the secondary plasma flows allows the powder injection tube to be located between the angled pipes inside which the secondary plasma flows travel. In this manner the injection tube is at an angle with a plane along which the plasma generated in the hollow tube travels (thus allowing for a shorter tube that does not follow the entire plasma torch), while still being coaxial to the combined plasma flow (therefore allowing axial injection of the feedstock).

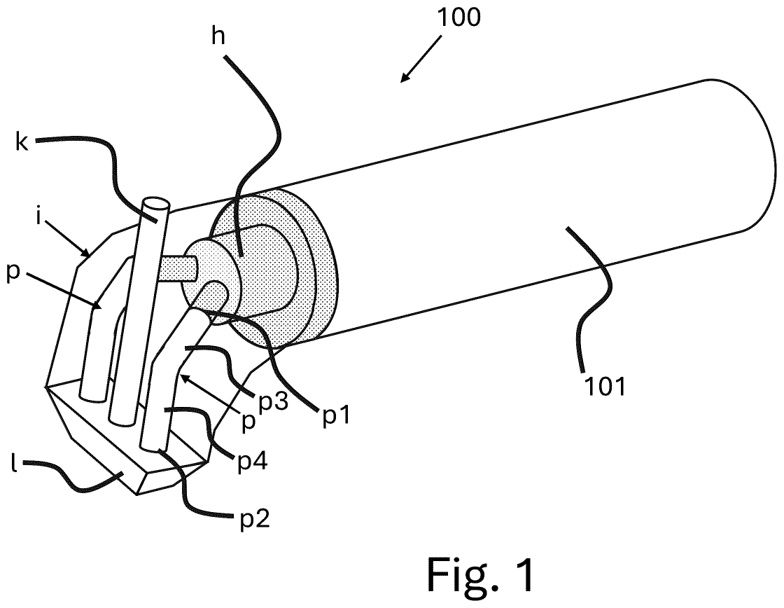

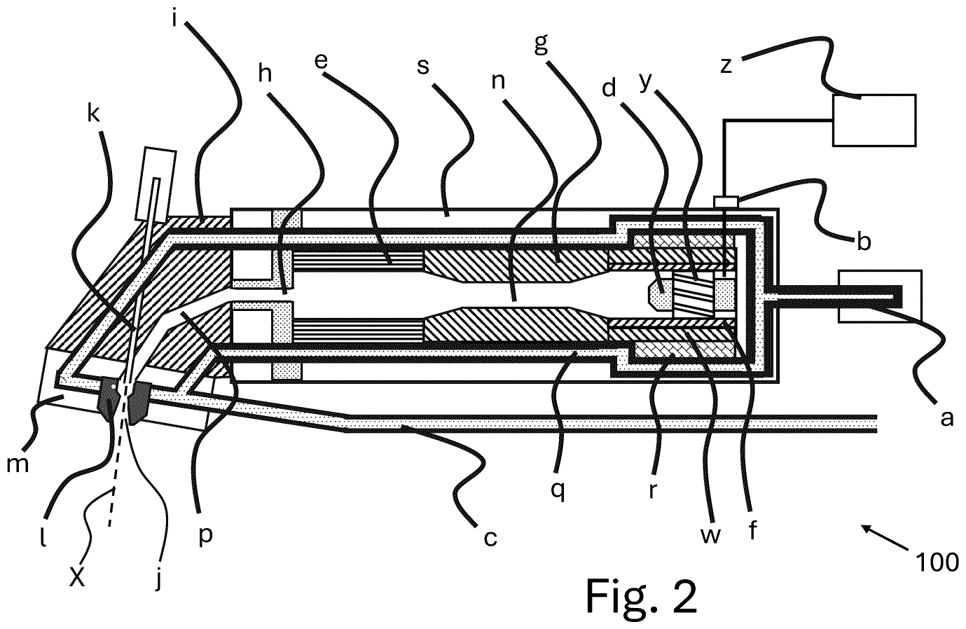

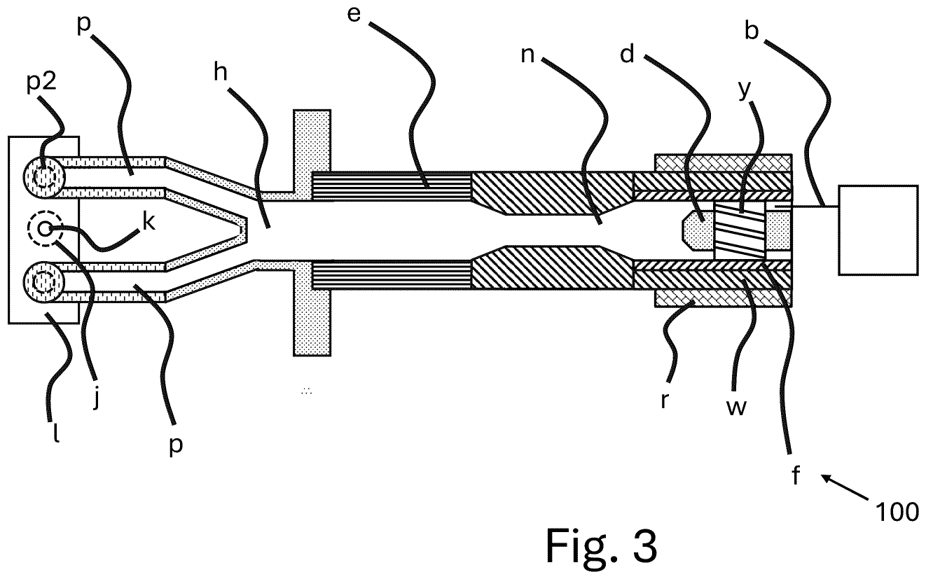

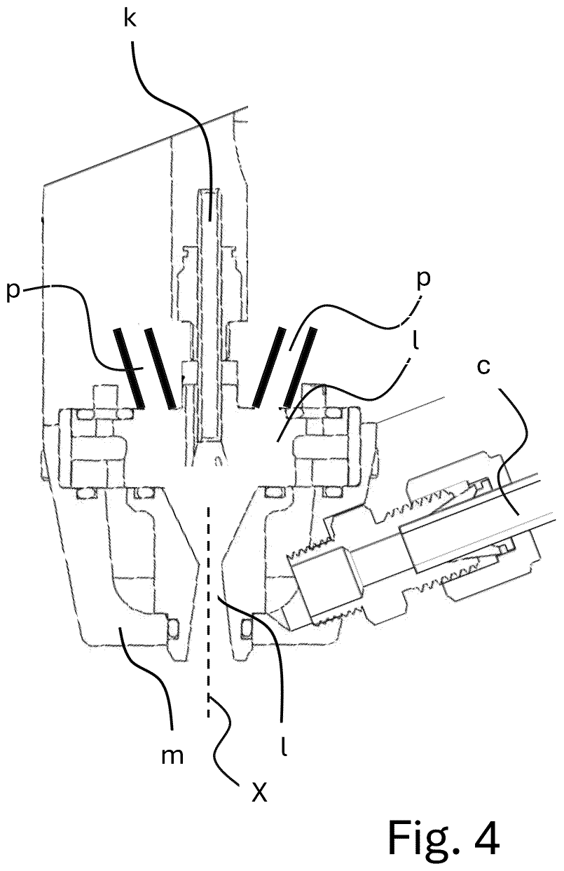

FIGS. 1-4 illustrate an axial plasma torch 100 in which the angled pipes lead plasma streams moving along a first axis onto a different axis angled with the first axis, according to some embodiments of the present invention. FIG. 1 is a three-dimensional view of a portion of the axial plasma torch. FIG. 2 is a side cross-sectional view of the axial plasma torch 100. FIG. 3 is a top cross-sectional view of the axial plasma torch 100. FIG. 4 is a front cross-sectional view of the convergence chamber and nozzle of the axial plasma torch 100.

Before describing the invention, the terms “proximal” and “distal” should be explained. The term “proximal” refers to a location that is closer to the location of the input of the gas into the plasma torch along a path of the from cathode to nozzle. The term distal refers to a location that is farther than the location the input of the gas into the plasma torch along a path of the from cathode to nozzle.

The axial plasma torch 100 includes a plasma generation unit 101, splitter (h), an elbow (i), a nozzle (n), and an injection tube (k). The plasma generation unit 101 generates a plasma stream, according to any known method or method that may be developed in the future.

In some embodiments of the present invention, the plasma generation unit 101 includes cathode (d), an anode (e), hollow tube (n), and gas input port (b).

The cathode (d) is a negative electrode where electrons emanate.

The anode (e) is a positive electrode.

The hollow tube (n) enables plasma to created between the anode and the cathode. The cathode (d) may partially extend inside the hollow tube (n), at the proximal end of the hollow tube. In some embodiments of the present invention the anode (e) forms a wall of the hollow tube (n) at a distal section of the hollow tube (n)

The gas input port (b) is configured to receive a flow of an input gas from a gas reservoir (z) and to lead the gas into the hollow tube (n) between the cathode (d) and the anode (e), such that an arc between the anode and the cathode turns the gas into a plasma in the hollow tube (n). The input gas may include one or more of argon, hydrogen, and nitrogen, for example.

The splitter (h) is joined to the plasma generation unit 101 (for example to the distal end of the hollow tube (n)) and is configured to receive the stream of plasma from the plasma generation unit to split the plasma to create multiple (at least two) secondary plasma streams. As will be seen further below, the splitter may be water cooled with through water cooling passages travelling perpendicular to the axial direction of the hollow tube.

The elbow (i) includes angled pipes (p) which are angled with respect to the plane of propagation of the plasma stream in the plasma generation unit 101 (e.g. along the hollow tube) and are configured to bend the secondary plasma streams with respect to the plane of propagation of the plasma stream in the plasma generation unit 101, thereby allowing axial injection with a straight powder tube (k). Each angled pipe (p) has a proximal opening (p1) and a distal opening (p2), and is configured to receive a respective secondary plasma streams from the splitter (h) via the proximal opening (p1) and to bend the secondary plasma stream.

The nozzle (l) receives the secondary plasma streams from the distal opening (p2) of angled pipes (p) and combines the multiple secondary plasma gas streams into a single combined plasma stream and provides an ejection hole (j) for emission of the combined plasma toward a target.

The injection tube (k) located at the elbow (i) between the plasma steams and extending into the nozzle (l). The injection tube is configured to inject feedstock into the combined stream at the in the nozzle in a direction parallel to the combined stream and the axis X of the nozzle. Thus, the injection tube provides axial injection of feedstock into the combined plasma stream within the nozzle section. The feedstock exits the nozzle (l) via the ejection hole (j) for deposition onto a target or solidification in a chamber or quenching device. The injection tube may be designed to handle feedstock in any form, such as powder, liquid suspension, or precursor solution.

The splitter, elbow, injection tube, and nozzle form a plasma jet formation unit, which receives the plasma stream from the plasma generating unit and forms and shapes a plasma jet to have one or more properties (e.g., speed, pressure, direction, density) within desired ranges.

In some embodiments of the present invention, the different elements of the torch 100 are cooled in order to prevent melting thereof by the temperature of the plasma. In a non-limiting example, the cooling occurs via a cooling system which includes a fluid input line, one or more cavities, and a water return line. The cooling fluid that enters via fluid input line (a), travels in the cavity (q), contacts predetermined elements of the torch 100 (for example, the outer surface of the wall of the hollow tube and parts of outer surfaces of walls of the curved pipes of the elbow) to absorb heat therefrom and exits via a fluid exit line (c). An example of the path of the cooling fluid is shown in FIG. 2. The cooling cavities may include holes, slots or channels and can incorporate selective fin cooling sections. The cooling fluid may be—for example—water (such as de-ionized water, distilled water) or a glycol-water mixture. Other coolants may be used, and the scope of the present invention extends to the use of any coolant.

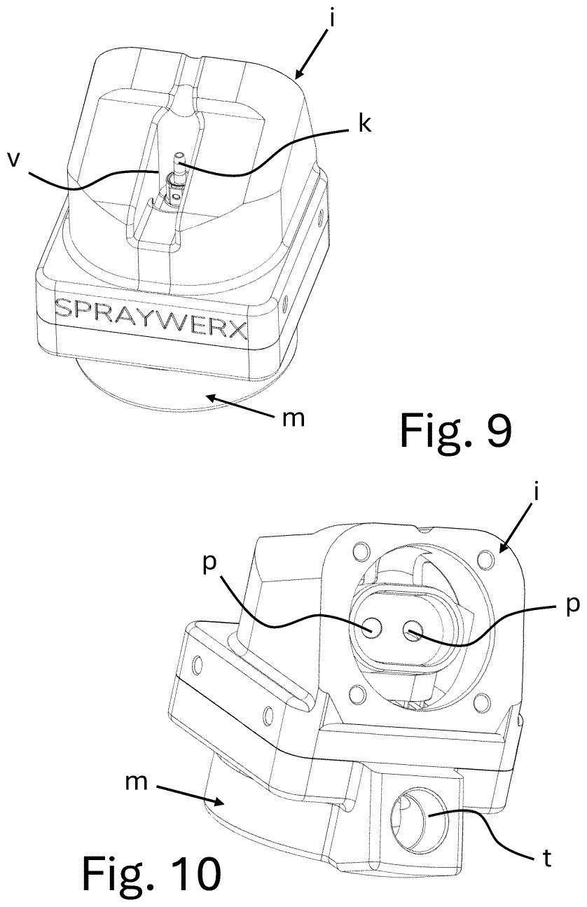

Optionally, a nozzle cap (m) holds the nozzle (l) and fluid collection basin (t) which collects the cooling fluid that has flowed along the plasma flows, and connects to the fluid exit line (c), as seen in FIGS. 9-13. The nozzle cap (m) may be removable, to enable the changing of the nozzle. A nozzle may be changed if worn out, or may be replaced by a longer or a shorter nozzle, in order to conform to different applications. In the example of FIG. 15, the nozzle cap (m) is longer than the nozzle cap (m) of FIGS. 9-14.

In some embodiments of the present invention, the torch 100 includes a torch insulating ring (f), encircling the cathode (d) and separating the cathode (d) from the wall (w) of the hollow tube (n) to prevent short circuits. In some embodiments of the present invention, the insulating ring (f) is made of a non-conductive ceramic. The ring (f) centers the cathode in the hollow tube (n). The cathode (d) includes passages (y) that lead the input gas from the gas input port (b) at or near the proximal end of the hollow tube distally into the remainder of the hollow tube (n). The gas passages (y) may be shaped helically to provide a swirl to the gas/plasma flow inside the hollow tube (n) in order to extend the arc.

The torch 100 may include a high temperature insulator (r). The high temperature insulator (r) is located around the outer walls of the hollow tube near the anode. In this manner, the high temperature that is created near the anode (and is necessary for the creation of plasma) is maintained near the anode.

The anode, cathode, hollow tube (n) and at least part of the splitter (h) may be contained in a body(s), which may include—for example—copper or copper alloy. A low temperature insulator may be included, to surround the body, to prevent electric shocks, burns and injuries that may occur by touching the outside body.

In some embodiments of the present invention, the system 100 includes an arc lengthening mechanism for lengthening the arc between the anode and the cathode and thereby increasing the arc's voltage. In some embodiments of the present invention, the arc lengthening mechanism includes a constriction (g) within a section of the hollow tube (n). A dimension (e.g., diameter, or side) in the constriction (g) is smaller than the corresponding dimension in a section of the hollow tube (n) extending on a proximal side of the constriction (g) and a section of the hollow tube (n) extending on a distal side of the constriction (g). The anode constriction may be located between the anode and the cathode and lengthens the arc between the anode and the cathode and increases the arc's voltage. U.S. Pat. No. 5,514,848 to Ross and Burgess (which is incorporated herein by reference) explains this feature in detail. In other embodiments of the present invention, the arc lengthening mechanism includes a cascading anode structure with neutrodes to lengthen the arc between the anode and the cathode, as described, for example in US Patent Publication 2014/0326703 to Molz (which is incorporated herein by reference). In yet other embodiments of the present invention, a third technique for lengthening the arc between the anode and the cathode be used, and is taught in U.S. Pat. No. 8,080,759 to Belaschenko (which is incorporated herein by reference). According to this third technique, the arc lengthening mechanism includes a pilot module (adjacent to the cathode) and an inter-electrode insert. The pilot module is configured to assist ignition of the system. The inter-electrode insert is located between the cathode and the anode, and may have an upstream and a downstream transverse surface. Both the upstream transverse surface and the downstream transverse surface are angled in a downstream direction. It should be noted that the arc lengthening unit is not limited to the three examples mentioned above, and the arc lengthening unit may include any known or future technology used for lengthening the arc between the cathode and anode.

The plasma torch of the present invention is advantageous as it uses a single pair of electrodes to create a plurality of plasma streams, and therefore a single power supply powering the electrode pair. Thus, capital cost and operation costs of the plasma torch are substantially reduced, compared to torches in which different plasma streams are created by different electrode pairs.

The single stream is split into multiple secondary streams by the splitter (h) which may incorporate precise orifices, (for example, made out of tungsten), to balance the flows between the multiple streams. The multiple streams are bent away from a propagation plane of the single stream in the hollow tube via respective angled pipes (p), to enable the positioning of the injection tube (k) between the curved pipes (p) and along the axis of the nozzle (l), and to discharge the feedstock axially into the combined stream before the combined stream leaves the torch via the nozzle (l). The fact that the injection tube (k) can be positioned along the axis of the nozzle (l) enables accurate axial injection of the feedstock material and improve the efficiency of feedstock material heating and processing compared to that would occur if the feedstock were injected at an angle with respect to the combined stream and with respect to the axis of the nozzle. Without the shoulder (i), the injection tube would have to be considerably longer in order to follow a large part (or the entirety) of the plasma stream and be parallel to the axis of the nozzle. The shoulder (i) with the angled tubes makes it possible to have a short injection tube (k) that effects axial injection, is parallel to the axis of the nozzle, and does not need to follow the length of the plasma stream.

The anode and cathode may be made of any of or a combination of copper, tungsten, a copper alloy, or a tungsten alloys, with the hot surfaces of the anode and cathode typically made from tungsten or doped tungsten. The splitter may be made of copper, tungsten, a copper alloy, or a tungsten alloy. The elbow (i), which includes the pipes (p) (for example, the pipes (p) may be bored into the elbow section) may be made copper, a copper alloy, or a copper tungsten alloy, or combinations thereof. The high temperature insulator (r) may be made of Al₂O₃. The low temperature insulator may be made of acetal homopolymer, such as Delrin plastic produced by Dupont. It should be noted that the materials mentioned above for the different elements of the torch are offered only as a non-limiting example, and the scope of the present invention is not limited to these materials, rather the scope extends any material (known or still) suitable for the construction and operation of the torch.

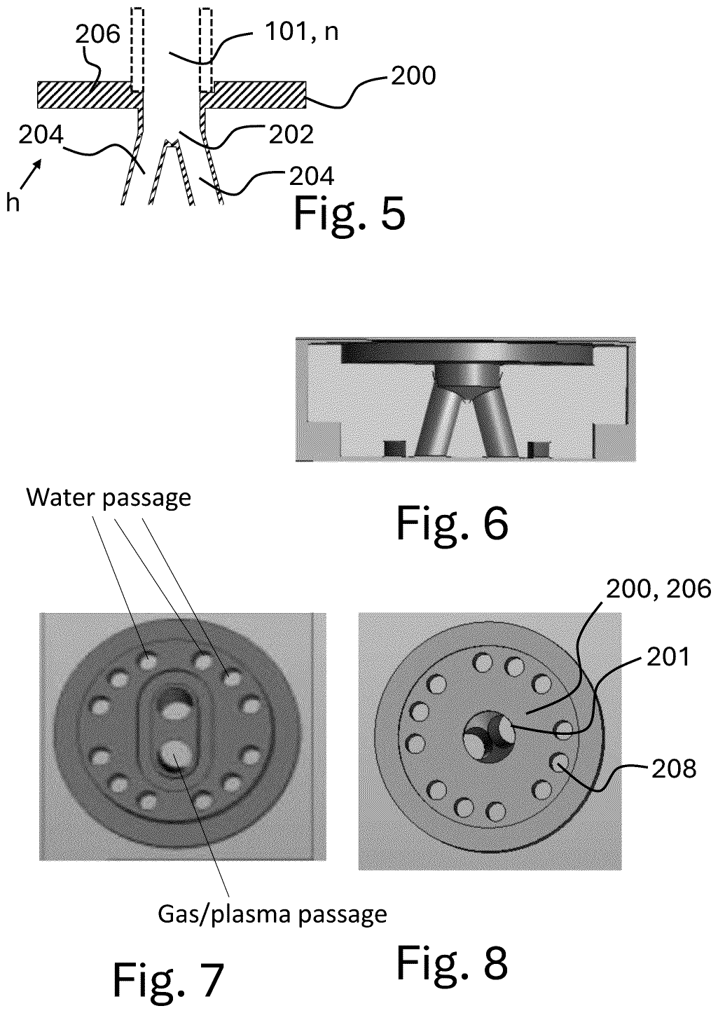

As shown in FIGS. 5-8, the splitter may include a panel 200 to facilitate mating to the hollow tube's structure, a first tube 202, and at least two second tubes 204. The panel 200 has perforation 201, and is joined to the plasma generation unit 101 (e.g., by covering a distal end of the hollow tube (n)), such that the plasma stream traversed the perforation 201. The first tube 202 extends downstream (distally) from the perforation 201 to receive the stream of the plasma. The second tubes 204 extend downstream (distally) from the first tube 201, to split the plasma stream of the plasma into the secondary plasma streams. In some embodiments of the present invention, more than two second tubes 204 may be present. In some embodiments of the present invention, the first tube is not present and the second tubes 202 extend directly from the perforation 201.

In some embodiments of the present invention, the panel 200 has an extension region 206 extending outward beyond a perimeter of the hollow tube (n) and includes a plurality of apertures 208 in the extension region, configured to be traversed by the cooling fluid, to enable the cooling fluid to flow inside the elbow around the angled pipes (p).

In the example of FIGS. 1-4, the plasma generating unit 101 produces a horizontal plasma stream (e.g., the hollow tube (n) extends horizontally). The splitter (h) has two second tubes, and is set horizontally, such that the second tubes extend along a horizontal plane. The angled pipes (p) are oriented at a non-zero angle with the horizontal plane, to bend the secondary plasma streams away from the horizontal plane. A gap is present between the pipes (p). This gap enables the injection tube (k) to be located between the pipes (p), therefore enabling axial injection of the feedstock into the combined plasma flow, in-line with the central axis X of the nozzle (n). In some embodiments of the present invention, the lengths of the paths of the secondary plasma streams (each path being the sum of the length of the respective second tube of the splitter and the respective angled pipe of the elbow) are equal. This enables the secondary plasma streams to be balanced. i.e., having substantially the same pressure, velocity, and density. In this manner, when the secondary plasma streams travel through the pipes (p), and combine within the nozzle section (l) a steady flow with a pressure and velocity within a desired range and a desired direction is created. Lack of balance in the flows may cause vortices inside the nozzle, giving rise to plasma leaving the nozzle at undesired velocities, pressure, and/or directions, because one of the secondary plasma flows dominate over the other(s), causing undesired feedstock flow within the nozzle.

In some non-limiting examples of the present invention, the length of each angled pipe is between 10 mm and 100 mm, or beyond, depending on the physical size of the torch. Any torch size is within the scope of the present invention. The lengths of the angled pipes are about equal with an error margin of up to 5%.

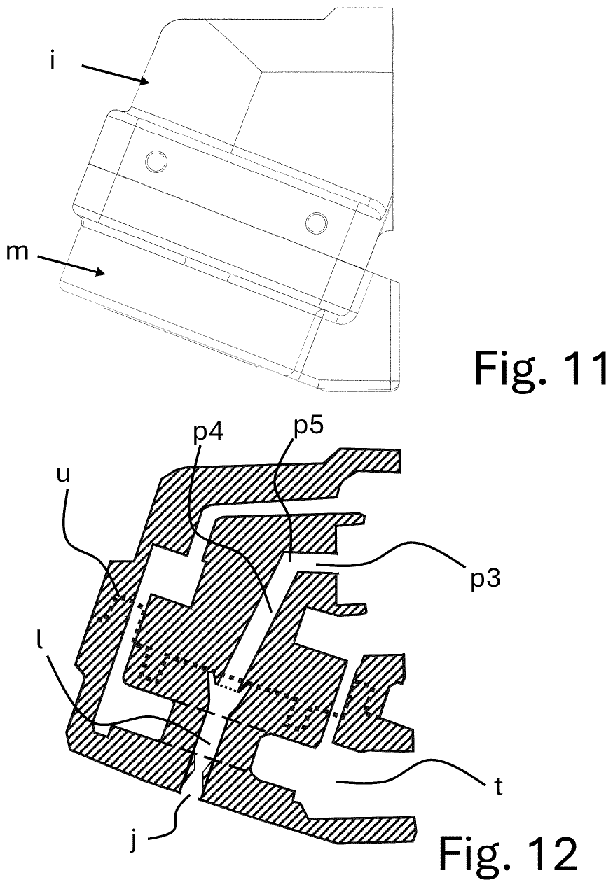

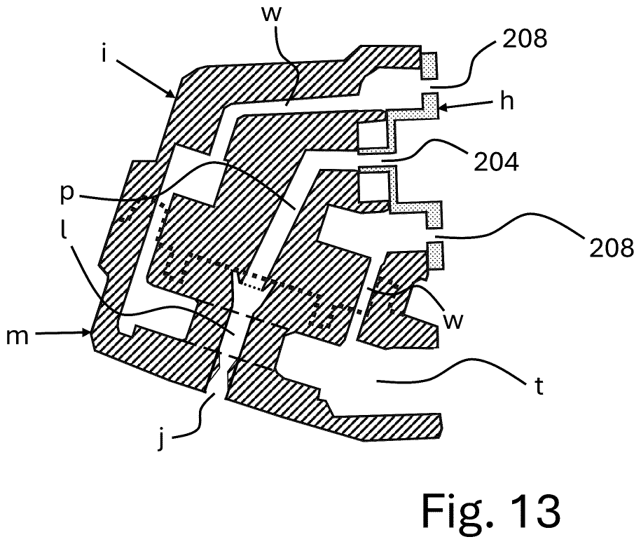

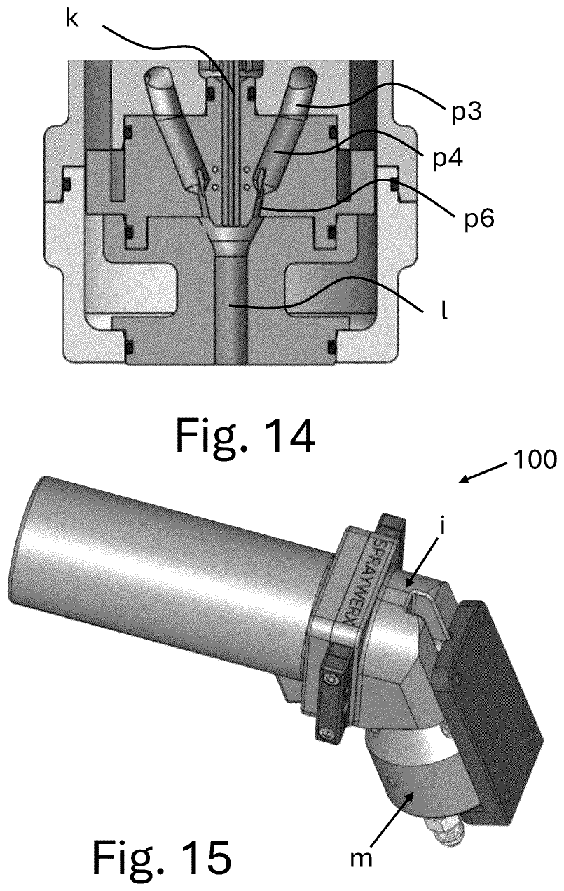

FIG. 9-14 illustrate details of the end unit which includes the shoulder (i) and nozzle cap (m), according to some embodiments of the present invention. FIG. 9 is a front three-quarters view of the end unit. FIG. 10 is a rear three-quarters view of the end unit. FIG. 11 is a side view of the end unit. FIG. 12 is a side cross-sectional view of the end unit. FIG. 13 is a side cross-sectional view of the end unit with a splitter joined thereto. FIG. 14 is a front cross-sectional view of the end unit. The dotted line (u) shows the border between the includes the shoulder (i) and nozzle cap (m).

In some embodiments of the present invention, the angled tubes (p) are in the form of cavities bored in a solid piece of material forming the elbow (i). The angled tubes (p) may be formed by two segments (a proximal segment p3 and a distal segment p4) meeting at a common juncture (p5) inside the shoulder (i). The proximal segment (p3) is bored into the shoulder (i) from a distal end of the shoulder (i), while the distal segment (p4) is bored into the shoulder (i) from a proximal end of the shoulder (i).

As seen in FIG. 13, the splitter (h) has second tubes 204 (only one of which is shown, as the second tubes are aligned along a horizontal plane) which split the plasm stream into two secondary plasma streams. Each second tube connects to a respective angled pipe (p), such that each secondary plasma stream flows through a respective angled pipe (p). In some embodiments of the present invention, the distal segments (p4) of the angled pipes (p) converge toward each other (but do not merge together), toward the nozzle (l). The convergence of the secondary plasma streams toward each other prior to combination in the nozzle (l) enables a smoother ejection of the secondary plasma streams into the nozzle, which enables decreased creation of vortices within the nozzle (l).

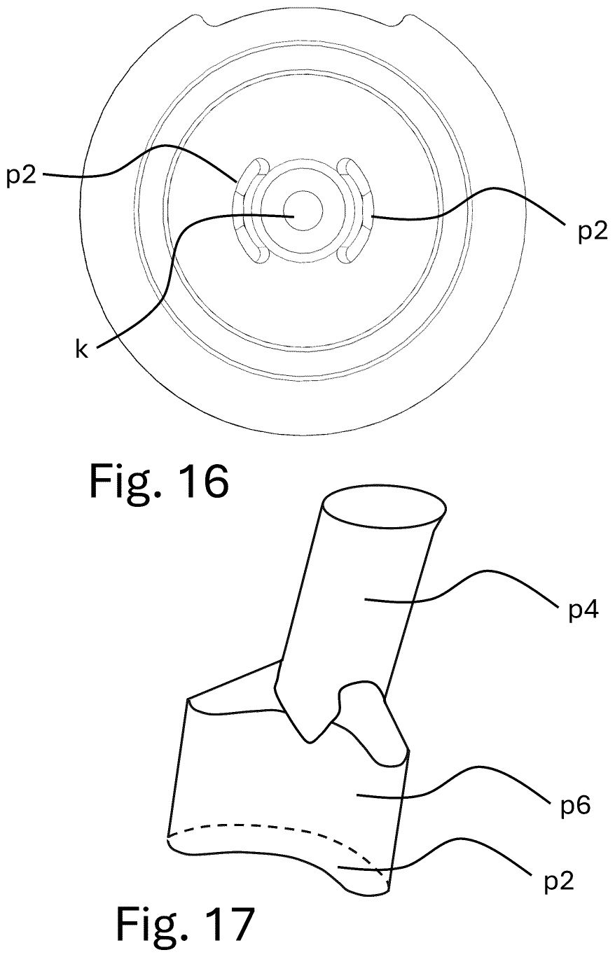

In some embodiments of the present invention, each distal segment (p4) has a distal end section (p6) which has a desired cross-sectional shape perpendicular to the length of the distal end section, which may differ than the cross-sectional shape of the remainder of the distal segment (p4). More specifically, the cross-sectional shape of the distal end section (p6) is the shape of the distal opening (p2) via which the secondary stream exits the pipe (p) and enters the nozzle. Shaping the secondary plasma stream to assume a cross-section matching the distal opening (p2) prior to entry into the nozzle enhances the smoothness of the entry of the secondary plasma stream into the nozzle. Moreover, the shape of the distal opening (p2) influences the properties of the combined plasma stream exiting the nozzle and the fixing of the feedstock with the plasma. The shape of the distal opening (p2) may be—for example—circular, rectangular, kidney shaped, or a combination of the above. In the non-limiting examples of FIGS. 16 and 17, the distal opening (p2) and the cross section of the distal end section (p6) are kidney-shaped. The distal openings are disposed such that the axis of the injection tube (k) is located between the distal openings (p).

The injection tube (k) ejects feedstock into the nozzle into the combined plasma stream. An ejection hole (j) opens at the distal end of the nozzle (l). The geometries of the distal segments (p4) and of the nozzle (l) determine the properties (direction, density, pressure, velocity) of flow of the combined plasma stream with feedstock out of the axial plasma torch.

In some embodiments of the present invention, the cooling fluid enters the shoulder (i) via the apertures 208 of the splitter (h). The cooling fluid travels inside one or more cavities (w) surrounding the pipes (p). The one or more cavities (w) lead the cooling fluid to the fluid collection basin (t), which is connected to the fluid exit line. The one or more cavities (w) are the distal sections of the cavity (q) of FIG. 2.

In some embodiments of the present invention, the elbow (i) includes a slit (v) for accessing an outer portion of the injection tube (k), for loading feedstock. The injection tube (k) may be fixed to the elbow (i) or may be removably joinable the elbow (i) for enabling replacement of the injection tube (k).

In some embodiment of the present invention, a plasma jet formation unit is provided and configured to be joined to a plasma generating unit and to shape a plasma stream generated by the plasma generating unit into a plasma jet. The plasma generating unit includes the anode, cathode, narrow gap, and gas input port, and generates the plasma stream. The plasma jet formation unit includes the splitter (h), the elbow (i), the injection tube (k), and the nozzle (l), as described above. The plasma jet formation unit receives the plasma stream from the plasma generating unit and generates a plasma jet with one or more desired parameters (e.g., speed, density, pressure, direction) for deposition of feedstock on a target or for the processing of feedstock. Feedstock for deposition or processing is injected into a combined plasma stream in the nozzle.

What is claimed is:

1. A plasma torch comprising:
a plasma generating unit, configured to generate a stream of plasma;
a splitter configured to receive the stream of the plasma from the plasma generating unit and to split the stream of the plasma into at least two secondary plasma streams;
an elbow comprising angled pipes, each angled pipe having a proximal opening and a distal opening, each angled pipe being configured to receive a respective one of the secondary plasma streams from the splitter via the proximal opening and to bend the secondary plasma streams;
a nozzle joined to the angled pipes and configured to receive the secondary plasma streams from the distal openings of angled pipes, to combine the secondary plasma streams into a single combined plasma stream, the nozzle having an ejection hole for ejecting the combined plasma stream out of the plasma torch;
an injection tube located between the angled pipes and configured to inject feedstock into the combined plasma stream at the nozzle, such that the feedstock mixes with the combined plasma stream in the nozzle and exits the plasma torch with the combined plasma stream via the ejection hole.

2. The plasma torch of claim 1, wherein the injection tube is configured to inject the feedstock co-axially to an axis of the nozzle.

3. The plasma torch of claim 1, wherein the plasma generating unit comprises:
a cathode;
an anode;
a hollow tube between the anode and the cathode;
a gas input port configured to receive a gas into the hollow tube, such an arc inside the hollow tube between the cathode and the anode converts the gas into the plasma.

4. The plasma torch of claim 3, comprising an arc lengthening mechanism configured to lengthen the arc between the anode and the cathode and thereby increase a voltage of the arc.

5. The plasma torch of claim 3, wherein the cathode partially extends into the hollow tube.

6. The plasma torch of claim 5, comprising an insulating ring disposed around the cathode to prevent contact between the cathode and a wall of the hollow tube.

7. The plasma torch of claim 5, wherein the cathode comprises passages configured to lead the input gas from the gas input port upstream into the hollow tube.

8. The plasma torch of claim 3, wherein the cathode is located in a proximal section of the hollow tube, while the anode forms a wall of the hollow at a distal section of the hollow tube.

9. The plasma torch of claim 1, wherein the injection tube is straight.

10. The plasma torch of claim 1, wherein the splitter comprises:
a panel having a perforation, the panel covering a distal end of the plasma generating unit, and receiving the stream of the plasma from the plasma generating unit via the perforation;
at least two tubes extending downstream from panel and being in fluid communication with the perforation, to split the stream of the plasma into the secondary plasma streams.

11. The plasma torch of claim 3, further comprising a cooling system which comprises:
a fluid input line;
one or more cavities configured to receive a flow of a cooling fluid from the fluid input line, the one or more cavities being in contact with at least a part of an outer surface of a wall of the hollow tube and with at least parts of outer surface of walls of the angled pipes of the elbow;
a fluid return line configured to receive the cooling fluid from the one or more cavities and direct the cooling fluid away from the plasma torch.

12. The plasma torch of claim 11, wherein the one or more cavities contact further the splitter and the nozzle.

13. The plasma torch of claim 11, wherein the splitter comprises:
a panel having a perforation, the panel covering a distal end of the hollow tube, the panel receiving the stream of plasma via the perforation;
at least two tubes extending downstream from the panel and in fluid communication with the perforation, to split the stream of the plasma into the secondary plasma streams;
wherein the panel has an extension region beyond a perimeter of hollow tube and comprises a plurality of apertures in the extension region, configured to be traversed by the cooling fluid.

14. The plasma torch of claim 11, comprising a nozzle cap comprising the nozzle and a fluid collection basin in fluid communication with the water return line.

15. The plasma torch of claim 1, comprising a nozzle cap which comprises the nozzle, the nozzle cap being removably joined to the elbow.

16. The plasma torch of claim 1, wherein each of the angled pipes comprises a straight proximal segment and a straight distal segment at a non-zero angle with the proximal segment, the proximal segment and the distal segment meeting at a common juncture.

17. The plasma torch of claim 1, wherein each of the angled pipes comprises a respective distal segment, the distal segments of the angle pipes converging toward each, before joining the nozzle.

18. The plasma torch of claim 17, wherein each of the distal segments of the angled pipes comprises a distal end section shaped differently than a remainder of the distal segment and matching a shape of the distal opening.

19. The plasma torch of claim 18, wherein the distal openings are circular, square, kidney-shaped or a combination thereof.

20. A plasma jet formation unit configured to be joined to a plasma generating unit and to shape a plasma stream generated by the plasma generating unit into a plasma jet, the plasma jet formation unit comprising:
a splitter configured to receive a stream of plasma generated by a plasma generating unit and to split the stream of the plasma into at least two secondary plasma streams;
an elbow comprising angled pipes, each angled pipe having a proximal opening and a distal opening, each angled pipe being configured to receive a respective one of the secondary plasma streams from the splitter via the proximal opening and to bend the secondary plasma streams;
a nozzle joined to the angled pipes and configured to receive the secondary plasma streams from the distal openings of angled pipes, to combine the secondary plasma streams into a single combined plasma stream, the nozzle having an ejection hole for ejecting the combined plasma stream out of the plasma jet formation unit; and
an injection tube located between the angled pipes and configured to inject feedstock into the combined plasma stream at the nozzle, such that the feedstock mixes with the combined plasma stream in the nozzle and exits the plasma jet formation unit with the combined plasma stream via the ejection hole.
